(19) United States
(12) Patent Application Publication
(10) Pub. No.: US 2015/0190832 A1
(43) Pub. Date: Jul. 9, 2015

(54) THIN FILM FORMING APPARATUS AND METHOD

(71) Applicant: Samsung Display Co., Ltd., Yongin-City (KR)

(72) Inventors: Jeong Ho YI, Suwon-si (KR); Sun Ho KIM, Seoul (KR); Cheol Rae JO, Osan-si (KR); Myung Soo HUH, Suwon-si (KR)

(73) Assignee: Samsung Display Co., Ltd., Yongin-City (KR)

(21) Appl. No.: 14/288,959

(22) Filed: May 28, 2014

(30) Foreign Application Priority Data
Jan. 3, 2014 (KR) 10-2014-0000746

(51) Int. Cl. B05B 12/14; B05C 9/12; B05B 7/16; B05B 7/24; B05D 1/00; B05D 3/06

(52) U.S. Cl. CPC B05B 12/1472; B05D 1/60; B05D 3/067; B05B 7/1686; B05B 7/2486; B05C 9/12

(57) ABSTRACT

A thin film forming apparatus comprises a first storage unit, a first nozzle unit, a first light-irradiating unit, a second storage unit, a second nozzle unit, and a second light-irradiating unit. The first storage unit is configured to store a first organic material. The first nozzle unit is connected to the first storage unit and is configured to spray the first organic material stored in the first storage unit. The first light-irradiating unit is disposed adjacent to the first nozzle unit and is configured to irradiate light having a wavelength that cures the first organic material. The second storage unit is configured to store a second organic material. The second nozzle unit is disposed adjacent to the first nozzle unit, is connected to the second storage unit, and is configured to spray the second organic material stored in the second storage unit. The second light-irradiating unit is disposed adjacent to the second nozzle unit and is configured to irradiate light having a wavelength that cures the second organic material.

This application claims priority from Korean Patent Application No. 10-2014-0000746 filed on Jan. 3, 2014 in the Korean Intellectual Property Office, the disclosure of which is incorporated herein by reference in its entirety.

### BACKGROUND

1. Field

The present application relates to a thin film forming apparatus and method, and more particularly, to an apparatus and method for forming an organic thin film on a substrate.

2. Description of the Related Art

An organic light-emitting element is a self-emitting element and is applicable to various products such as thin and bendable display devices. However, when the organic light-emitting element is exposed to moisture and oxygen introduced from the external environment, its properties deteriorate rapidly.

Therefore, the organic light-emitting element is encapsulated using a can or a glass substrate. Generally, a polymer material such as ultraviolet (UV) or thermosetting epoxy or acryl is used as a sealant. However, since the polymer material has a poor moisture-proofing capability, properties (e.g., luminance) of the organic light-emitting element are degraded over time by moisture and oxygen introduced toward the organic light-emitting element. Consequently, the life of the organic light-emitting element is reduced. Therefore, a moisture absorbent may be placed within a device to prevent moisture that passes through the sealant from affecting the organic light-emitting element. However, this method complicates the manufacturing process and increases the weight and volume of a display device.

To solve this problem, thin film encapsulation technology has been suggested. The thin film encapsulation technology encapsulates a display element by covering the display element with a protective film. The thin film encapsulation may have a structure in which an organic film or an inorganic film is stacked at least once. To form an encapsulation film having this structure, a technology of forming a thin film on a substrate is required. Accordingly, various technological attempts are being made to come up with an apparatus and method for forming a thin film on a substrate.

### SUMMARY

Embodiments provide a thin film forming apparatus which forms at least one organic thin film on a substrate.

Embodiments also provide a thin film forming apparatus which reduces the time required to form a plurality of organic films on a substrate.

Embodiments also provide a thin film forming method employed to form at least one organic thin film on a substrate.

However, embodiments are not restricted to the ones set forth herein. The above and other embodiments will become more apparent to one of ordinary skill in the art to which the present application pertains by referencing the detailed description given below.

According to one embodiment, there is provided a thin film forming apparatus comprising a first storage unit, a first nozzle, a first light-irradiating unit, a second storage unit, a second nozzle unit, and a second light-irradiating unit. The first storage unit is configured to store a first organic material. The first nozzle unit is connected to the first storage unit and is configured to spray the first organic material stored in the first storage unit. The first light-irradiating unit is disposed adjacent to the first nozzle unit and is configured to irradiate light having a wavelength that cures the first organic material. The second storage unit is configured to store a second organic material. The second nozzle unit is disposed adjacent to the first nozzle unit, is connected to the second storage unit, and is configured to spray the second organic material stored in the second storage unit. The second light-irradiating unit is disposed adjacent to the second nozzle unit and is configured to irradiate light having a wavelength that cures the second organic material.

According to another embodiment, there is provided a thin film forming apparatus comprising a first nozzle unit, a second nozzle unit, a first storage unit, a second storage unit, a first light-irradiating unit, and a second light-irradiating unit. The first nozzle unit and the second nozzle unit extend along a lengthwise direction and are disposed side by side with each other. The first storage unit is connected to the first nozzle unit and is configured to store a first organic material. The second storage unit is connected to the second nozzle unit and is configured to store a second organic material. The first light-irradiating unit is disposed adjacent to a first side of the first nozzle unit and extends side by side with the first nozzle unit. The second light-irradiating unit is disposed adjacent to a second side of the second nozzle unit and extends side by side with the second nozzle unit.

According to another embodiment, a thin film forming method comprising a first scan operation of forming a first thin film on a substrate by moving the substrate along a first direction and a second scan operation of forming a second thin film by moving the substrate along a second direction opposite to the first direction. Each of the first scan operation and the second scan operation comprises providing any one or more of a first organic material and a second organic material onto the substrate and irradiating any one or more of first UV light and second UV light onto the substrate.

### BRIEF DESCRIPTION OF THE DRAWINGS

The above and other aspects and features of the inventive concept will become more apparent by describing in detail exemplary embodiments thereof with reference to the attached drawings, in which:

FIG. 1 is a block diagram of an organic thin film forming apparatus according to an embodiment;

FIG. 2 is a block diagram of a thin film forming apparatus according to another embodiment;

FIG. 3 is a plan view of a thin film forming apparatus according to an embodiment;

FIG. 4 is a cross-sectional view taken along the line I-I′ of FIG. 3;

FIG. 5 is a cross-sectional view of the thin film forming apparatus of FIG. 3;

FIG. 6 is a cross-sectional view of the thin film forming apparatus of FIG. 3;

FIG. 7 is a plan view of the thin film forming apparatus of FIG. 6;

FIG. 8 is a cross-sectional view of the thin film forming apparatus of FIG. 7;

FIG. 9 is a cross-sectional view of a substrate having a thin film formed by the thin film forming apparatus of FIG. 8;

FIG. 10 is a plan view of the thin film forming apparatus of FIG. 3;

FIG. 11 is a cross-sectional view of the thin film forming apparatus of FIG. 10;

FIG. 12 is a cross-sectional view of the substrate having a thin film formed by the thin film forming apparatus of FIG. 11;

FIG. 13 is a cross-sectional view of the thin film forming apparatus of FIG. 7;

FIG. 14 is a cross-sectional view of a substrate having a thin film formed by the thin film forming apparatus of FIG. 13;

FIGS. 15, 16, 17, 18 are cross-sectional views of thin films formed on a substrate by the thin film forming apparatus of FIG. 3;

FIG. 19 is a cross-sectional view of a thin film forming apparatus according to another embodiment; and

FIGS. 20, 21, 22 are plan views illustrating the operation of the thin film forming apparatus of FIG. 19.

### DETAILED DESCRIPTION

The aspects and features of the inventive concept and methods for achieving the aspects and features will be apparent by referring to the embodiments to be described in detail with reference to the accompanying drawings. However, the inventive concept is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the inventive concept, and the inventive concept is only defined within the scope of the appended claims.

The term “on” that is used to designate that an element is on another element or located on a different layer or a layer includes both a case where an element is located directly on another element or a layer and a case where an element is located on another element via another layer or still another element. In the entire description, the same drawing reference numerals are used for the same elements across various figures.

Although the terms “first, second, and so forth” are used to describe diverse constituent elements, such constituent elements are not limited by the terms. The terms are used only to discriminate a constituent element from other constituent elements. Accordingly, in the following description, a first constituent element may be a second constituent element.

Hereinafter, embodiments will be described with reference to the attached drawings.

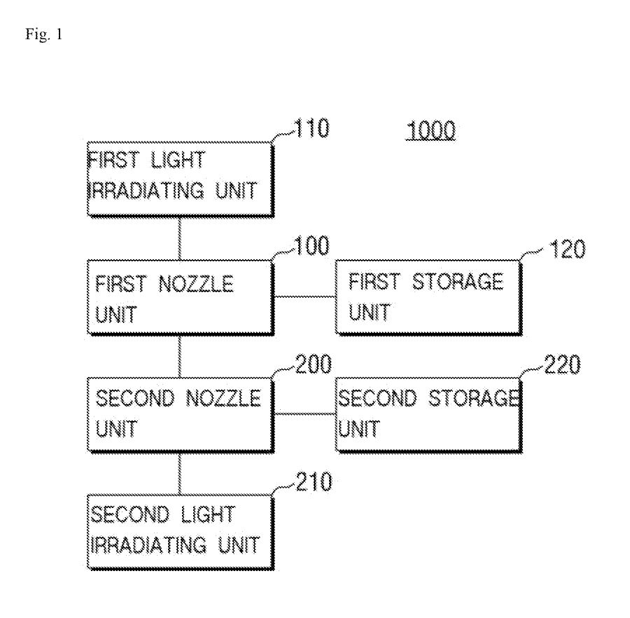

FIG. 1 is a block diagram of an organic thin film forming apparatus 1000 according to an embodiment.

Referring to FIG. 1, the thin film forming apparatus 1000 according to the current embodiment includes a first storage unit 120, a first nozzle unit 100, a first light-irradiating unit 110, a second storage unit 220, a second nozzle unit 200, and a second light-irradiating unit 210. The first storage unit 120 stores a first organic material. The first nozzle unit 100 is connected to the first storage unit 120 and sprays the first organic material stored in the first storage unit 120. The first light-irradiating unit 110 is disposed adjacent to the first nozzle unit 100 and irradiates light having a wavelength that cures the first organic material. The second storage unit 220 stores a second organic material. The second nozzle unit 200 is disposed adjacent to the first nozzle unit 100, is connected to the second storage unit 220, and sprays the second organic material stored in the second storage unit 220. The second light-irradiating unit 210 is disposed adjacent to the second nozzle unit 200 and irradiates light having a wavelength that cures the second organic material.

The first storage unit 120 stores the first organic material. The first storage unit 120 may store the first organic material in a gaseous, liquid or solid state. That is, the phase of the first organic material stored in the first storage unit 120 is not limited to a particular phase.

The first organic material may include all organic materials used to form a thin film. That is, the first organic material may be any organic material that is now used in a thin film forming process or that can be used depending on future technological developments. In other words, the organic material, as used herein, is not limited to a particular type of material.

The first nozzle unit 100 may be connected to the first storage unit 120. That is, a passage may be formed between the first storage unit 120 and the first nozzle unit 100. Accordingly, the first organic material stored in the first storage unit 120 may be sprayed through the first nozzle unit 100.

The first nozzle unit 100 and the first storage unit 120 may be connected by a connecting medium such as at least one pipe or tube. However, this is merely an example, and the first nozzle unit 100 and the first storage unit 120 can be connected in various ways.

The first nozzle unit 100 may spray the first organic material stored in the first storage unit 120 toward a substrate. In an example, the first nozzle unit 100 may spray the first organic material stored in the first storage unit 120 in a liquid, gaseous or aerosol form.

The first light-irradiating unit 110 may be disposed adjacent to the first nozzle unit 100. The first light-irradiating unit 110 may irradiate light toward the first organic material sprayed from the first nozzle unit 100. In other words, the first light-irradiating unit 110 may irradiate light toward the first organic material sprayed onto the substrate from the first nozzle unit 100. In an example, the first light-irradiating unit 110 may irradiate light of an ultraviolet (UV) wavelength. However, this is merely an example, and the wavelength of light irradiated by the first light-irradiating unit 110 is not limited to the UV wavelength.

The curing wavelength may vary according to the type of the first organic material. That is, an organic material of a certain type may be cured by light having a certain range of wavelengths. In an example, the first light-irradiating unit 110 may irradiate light having a wavelength corresponding to the first organic material. In other words, the first light-irradiating unit 110 may irradiate light having a wavelength that cures the first organic material. That is, the wavelength of light irradiated by the first light-irradiating unit 110 may vary according to the type of the first organic material.

The thin film forming apparatus 1000 according to the current embodiment may further include the second storage unit 220 which stores the second organic material. The second storage unit 220 may be substantially the same as the first storage unit 120 described earlier.

That is, the second storage unit 220 may store the second organic material. The second storage unit 220 may store the second organic material in a gaseous, liquid or solid state. That is, the phase of the second organic material stored in the second storage unit 220 is not limited to a particular phase.

The second organic material may be, but is not limited to, different from the first organic material. The second organic material may include all organic materials used to form a thin film. That is, the second organic material may be any organic material that is now used in a thin film forming process or that can be used depending on future technological developments. In other words, the organic material, as used herein, is not limited to a particular type of material.

The second nozzle unit 200 may be substantial the same as the first nozzle unit 100. The second nozzle unit 200 may be connected to the second storage unit 220. That is, a passage may be formed between the second storage unit 220 and the second nozzle unit 200. Accordingly, the second organic material stored in the second storage unit 220 may be sprayed through the second nozzle unit 200.

The second nozzle unit 200 and the second storage unit 220 may be connected by a connecting medium such as at least one pipe or tube. However, this is merely an example, and the second nozzle unit 200 and the second storage unit 220 can be connected in various ways.

The second nozzle unit 200 may spray the second organic material stored in the first storage unit 220 toward the substrate. In an example, the second nozzle unit 200 may spray the second organic material stored in the second storage unit 220 in a liquid, gaseous or aerosol form.

The second nozzle unit 200 may be disposed adjacent to the first nozzle unit 100. In an exemplary embodiment, the second nozzle unit 200 may be disposed side by side with the first nozzle unit 100. This will not be described in detail.

The second light-irradiating unit 210 may be disposed adjacent to the second nozzle unit 200. The second light-irradiating unit 210 may irradiate light toward the second organic material sprayed from the second nozzle unit 200. In other words, the second light-irradiating unit 210 may irradiate light toward the second organic material sprayed onto the substrate from the second nozzle unit 200. In an example, the second light-irradiating unit 210 may irradiate light of a UV wavelength. However, this is merely an example, and the wavelength of light irradiated by the second light-irradiating unit 210 is not limited to the UV wavelength.

The curing wavelength may vary according to the type of the second organic material. That is, an organic material of a certain type may be cured by light having a certain range of wavelengths. In an example, the second light-irradiating unit 210 may irradiate light having a wavelength corresponding to the second organic material. In other words, the second light-irradiating unit 210 may irradiate light having a wavelength that cures the second organic material. That is, the wavelength of light irradiated by the second light-irradiating unit 210 may vary according to the type of the second organic material.

The thin film forming apparatus 1000 configured as described above may form at least one organic thin film on the substrate. In an exemplary embodiment, the thin film forming apparatus 1000 according to the current embodiment and the substrate may move relative to each other, and such relative movement may result in the formation of at least one organic film on the substrate. This will be described in detail later.

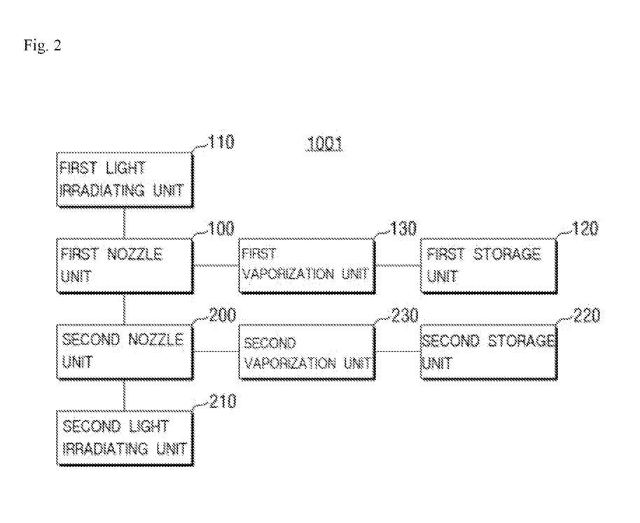

FIG. 2 is a block diagram of a thin film forming apparatus 1001 according to another embodiment.

Referring to FIG. 2, the thin film forming apparatus 1001 according to the current embodiment may further include a first vaporization unit 130 and a second vaporization unit 230 which vaporize a first organic material and a second organic material stored in a first storage unit 120 and a second storage unit 220, respectively.

In an exemplary embodiment, the first storage unit 120 and the second storage unit 220 respectively may store the first organic material and the second organic material in a liquid form.

The first vaporization unit 130 and the second vaporization unit 230 may vaporize the liquid first organic material and the liquid second organic material stored in the first storage unit 120 and the second storage unit 220, respectively. That is, the first organic material and the second organic material vaporized by the first vaporization unit 130 and the second vaporization unit 230 may be sprayed through a first nozzle unit 100 and a second nozzle unit 200. In other words, the first nozzle unit 100 and the second nozzle unit 200 may spray the first organic material and the second organic material vaporized by the first vaporization unit 130 and the second vaporization unit 230, respectively.

Hereinafter, more specific embodiments will be described with reference to the attached drawings.

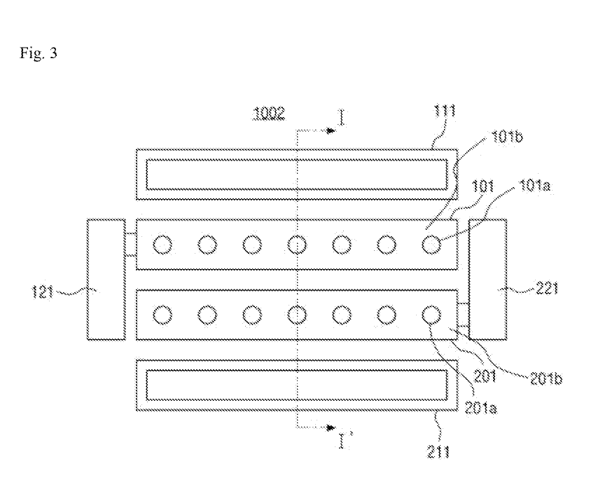

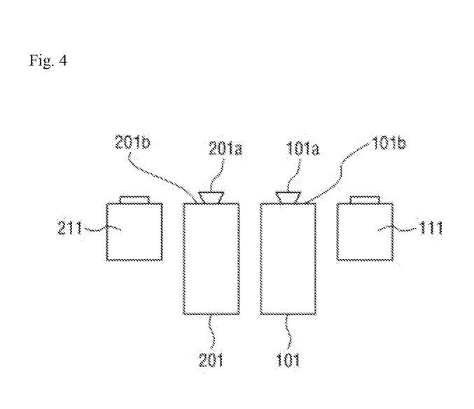

FIG. 3 is a plan view of a thin film forming apparatus 1002 according to an embodiment. FIG. 4 is a cross-sectional view taken along the line I-I′ of FIG. 3.

Referring to FIGS. 3 and 4, the thin film forming apparatus 1002 according to the current embodiment includes a first nozzle unit 101, a second nozzle unit 201, a first storage unit 121, a second storage unit 221, a first light-irradiating unit 111, and a second light-irradiating unit 211. The first nozzle unit 101 and the second nozzle unit 201 extend along a lengthwise direction and are disposed side by side with each other. The first storage unit 121 is connected to the first nozzle unit 101 and stores a first organic material. The second storage unit 221 is connected to the second nozzle unit 201 and stores a second organic material. The first light-irradiating unit 111 is disposed adjacent to a first side of the first nozzle unit 101 and extends side by side with the first nozzle unit 101. The second light-irradiating unit 211 is disposed adjacent to a second side of the second nozzle unit 201 and extends side by side with the second nozzle unit 201.

In an exemplary embodiment, the first nozzle unit 101 may extend along the lengthwise direction. That is, the first nozzle unit 101 may be shaped like a bar extending along the lengthwise direction. The first nozzle unit 101 may have a body 101b extending along the lengthwise direction and one or more spray holes 101a formed on the body. In an exemplary embodiment, the spray holes 101a may be arranged along the lengthwise direction. In FIG. 3, a plurality of spray holes 101a are arranged in a row. However, this is merely an example, and the arrangement of the spray holes 101a is not limited to this example. That is, the spray holes 101a may also be arranged in a matrix having one or more rows and one or more columns.

Each of the spray holes 101a may be open on an upper side thereof. In an exemplary embodiment, the spray holes 101a may be fixed in position, and a substrate may move horizontally over the spray holes 101a to form a thin film on the substrate. A specific process of forming a thin film on the substrate will be described later.

The first storage unit 121 may be disposed at a first end of the first nozzle unit 101. The first storage unit 121 may store the first organic material and may be connected to the first nozzle unit 101. That is, the first organic material stored in the first storage unit 121 may be sprayed through the first nozzle unit 101. The first organic material may be stored in a liquid, solid or gaseous state as described above. In addition, although not illustrated in the drawings, if the first organic material is liquid, the thin film forming apparatus 1002 according to embodiments may further include a first vaporization unit which vaporizes the first organic material.

The first light-irradiating unit 111 may be disposed adjacent to the first side of the first nozzle unit 101. The first light-irradiating unit 111 may extend along the lengthwise direction. That is, the first light-irradiating unit 111 may be disposed side by side with the first nozzle unit 101. In an exemplary embodiment, the first light-irradiating unit 111 may include a first UV lamp (not shown).

The first light-irradiating unit 111 may irradiate first UV light having a certain wavelength. In an example, the first UV light irradiated by the first light-irradiating unit 111 may have a wavelength that cures the first organic material provided on the substrate. That is, the wavelength of the first UV light may vary according to the type of the first organic material.

The second nozzle unit 201 may be disposed adjacent to a second side of the first nozzle unit 101. The second nozzle unit 201 may extend along the lengthwise direction. That is, the second nozzle unit 201 may be linear. The second nozzle unit 201 may have a body 201b extending along the lengthwise direction and one or more spray holes 201a formed on the body. In an exemplary embodiment, the spray holes 201a may be arranged along the lengthwise direction. In FIG. 3, a plurality of spray holes 201a are arranged in a row. However, this is merely an example, and the arrangement of the spray holes 201a is not limited to this example. That is, the spray holes 201a may also be arranged in a matrix having one or more rows and one or more columns.

Each of the spray holes 201a may be open on an upper side thereof. In an exemplary embodiment, the spray holes 201a may be fixed in position, and the substrate may move horizontally over the spray holes 201a to form a thin film on the substrate. A specific process of forming a thin film on the substrate will be described later.

The second storage unit 221 may be disposed at a second end of the second nozzle unit 201. That is, the first nozzle unit 101 and the second nozzle unit 201 may be disposed between the first storage unit 121 and the second storage unit 221. However, this is merely an example, and the position of the storage unit 121 and the second storage unit 221 is not limited this example. The first storage unit 121 and the second storage unit 221 can be placed at any position as long as they can be connected to the first nozzle unit 101 and the second nozzle unit 201. That is, the scope of the present embodiment is not limited by the position of the first storage unit 121 and the second storage unit 221.

The second storage unit 221 may store the second organic material and may be connected to the second nozzle unit 201. That is, the second organic material stored in the second storage unit 221 may be sprayed through the second nozzle unit 201. The second organic material may be stored in a liquid, solid or gaseous state as described above. In addition, although not illustrated in the drawings, if the second organic material is liquid, the thin film forming apparatus 1002 according to the embodiments may further include a second vaporization unit which vaporizes the second organic material.

The second light-irradiating unit 211 may be disposed adjacent to the second side of the second nozzle unit 201. That is, the first nozzle unit 101 and the second nozzle unit 201 may be disposed between the second light-irradiating unit 211 and the first light-irradiating unit 111. The second light-irradiating unit 211 may extend along the lengthwise direction. That is, the second light-irradiating unit 211 may be disposed side by side with the second nozzle unit 201. The second light-irradiating unit 211 may include a second UV lamp (not shown).

The second light-irradiating unit 211 may irradiate second UV light having a certain wavelength. In an example, the second UV light irradiated by the second light-irradiating unit 211 may have a wavelength that cures the second organic material provided on the substrate. That is, the wavelength of the second UV light may vary according to the type of the second organic material.

The operation of the thin film forming apparatus 1002 according to the embodiments will now be described in detail.

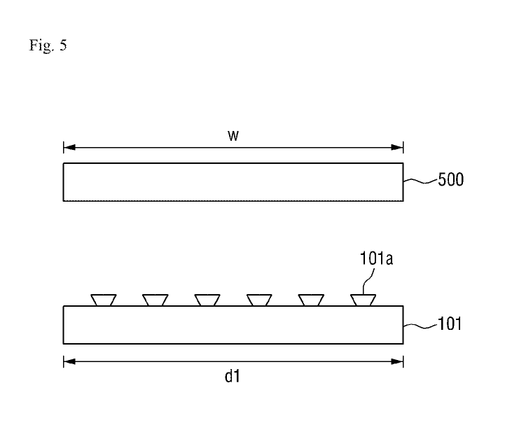

FIG. 5 is a cross-sectional view of the thin film forming apparatus of FIG. 3.

Referring to FIG. 5, a substrate 500 may be placed above the thin film forming apparatus according to the current embodiment.

The substrate 500, as used herein, is a display substrate that displays an image. The display substrate may be a liquid crystal display (LCD) substrate, an electrophoretic display substrate, an organic light-emitting diode (OLED) display substrate, a light-emitting diode (LED) display substrate, an inorganic electroluminescent (EL) display panel substrate, a field emission display (FED) substrate, a surface-conduction electron-emitter display (SED) substrate, a plasma display panel (PDP) display substrate, or a cathode ray tube (CRT) display substrate.

The above types of the display substrate are merely examples, and the type of the display substrate is limited to the above examples. In addition, the display substrate may be a rigid substrate or a flexible substrate that can be bent, folded, or rolled.

In an exemplary embodiment, the thin film forming apparatus may be used to form an encapsulation film of an OLED. That is, an encapsulation film of an OLED may be manufactured using the thin film forming apparatus according to one embodiment. As used herein, the substrate 500 may be a substrate having some elements formed before the formation of an encapsulation film.

The substrate 500 may be placed above the thin film forming apparatus. That is, the thin film forming apparatus and a surface of the substrate 500 may be separated by a predetermined distance and may be placed to face each other.

The thin film forming apparatus according to one embodiment may move relative to the substrate 500 placed thereabove. That is, the thin film forming apparatus may be fixed in position, and the substrate 500 placed above the thin film forming apparatus may move horizontally. Alternatively, the substrate 500 may be fixed in position, and the thin film forming apparatus may move horizontally.

For ease of description, a case where the thin film forming apparatus is fixed while the substrate 500 moves horizontally will hereinafter be described as an example, but the scope of the present embodiment is not limited to this case.

Referring to FIG. 5, a width w of the substrate 500 may be substantially equal to a length d1 of the thin film forming apparatus. That is, the length d1 of the thin film forming apparatus may correspond to the width w of the substrate 500. In other words, in a state where a first side of the substrate 500 is placed parallel to a direction in which the thin film forming apparatus extends, the substrate 500 may move in a direction perpendicular to the direction in which the thin film forming apparatus extends. Accordingly, the substrate 500, from the first side of the substrate 500 to a second side thereof, may pass directly over the thin film forming apparatus. When the length d1 of the thin film forming apparatus has a value corresponding to the width w of the substrate 500, if the substrate 500 passes directly over the thin film forming apparatus, one thin film may be formed on the whole area of the substrate 500.

The length d1 of the thin film forming apparatus may not necessarily be equal to the width w of the substrate 500 and may also be smaller than the width w of the substrate 500. In this case, the substrate 500 may move at least once in a lengthwise direction of the thin film forming apparatus and in a direction perpendicular to the lengthwise direction of the thin film forming apparatus, thereby forming a thin film on the whole area of the substrate 500. This will be described in detail later.

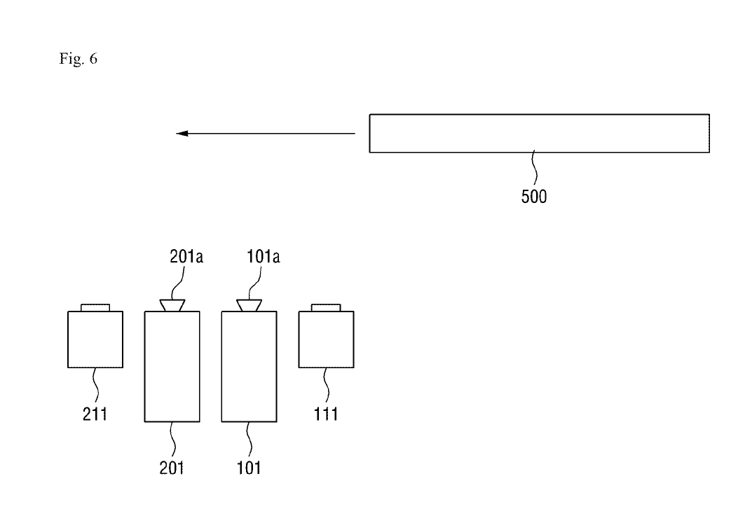

FIG. 6 is a cross-sectional view of the thin film forming apparatus of FIG. 3.

Referring to FIG. 6, the substrate 500 placed above the thin film forming apparatus according to the current embodiment may move in a first direction.

The first direction may be the direction perpendicular to the direction in which the thin film forming apparatus extends.

As the substrate 500 moves along the first direction, it may pass over the thin film forming apparatus sequentially from the first side of the substrate 500 to the second side thereof. That is, as the substrate 500 moves along the first direction, a thin film may be formed on the substrate 500 sequentially from the first side of the substrate 500 to the second side thereof. That is, when the second side of the substrate 500 moving along the first direction passes the thin film forming apparatus, one thin film may be formed on the whole area of the substrate 500.

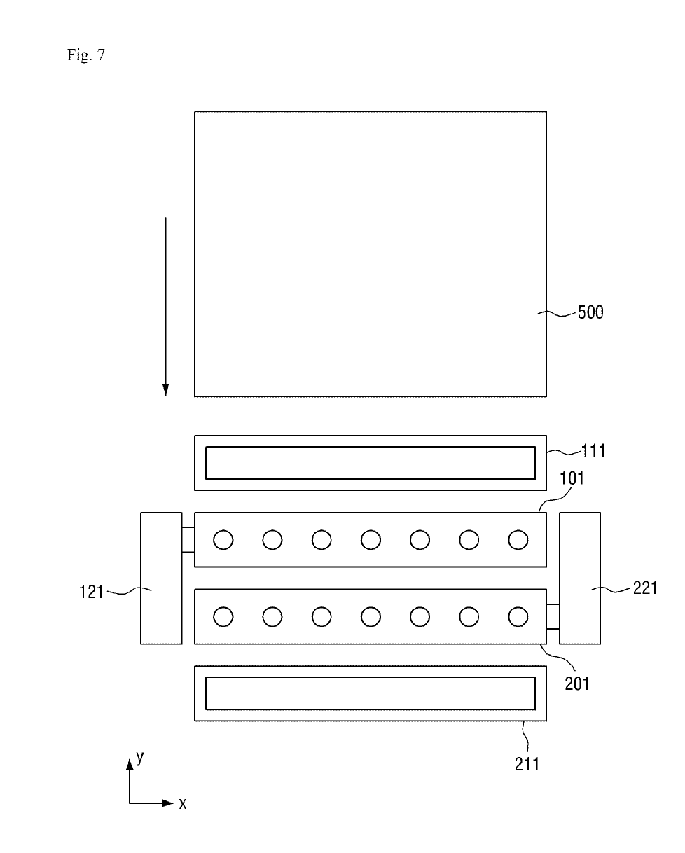

As the substrate 500 moves along the first direction, the first nozzle unit 101 and/or the second nozzle unit 201 may provide the first organic material or the second organic material toward the substrate 500. At the same time or subsequently, the first light-irradiating unit 111 and/or the second light-irradiating unit 211 may irradiate light that cures the first organic material and/or the second organic material toward the substrate 500. This will now be described in detail with reference to FIGS. 7 through 12.

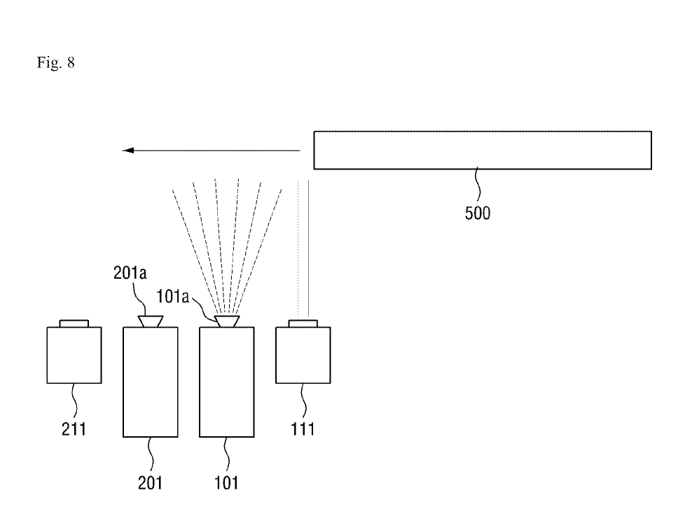

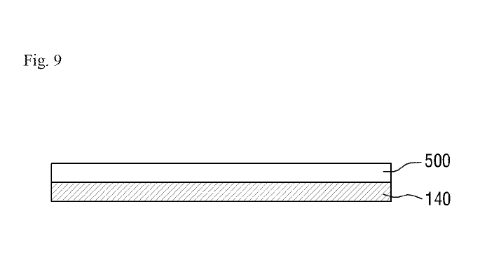

FIG. 7 is a plan view of the thin film forming apparatus of FIG. 6. FIG. 8 is a cross-sectional view of the thin film forming apparatus of FIG. 7. FIG. 9 is a cross-sectional view of the substrate 500 having a thin film formed by the thin film forming apparatus of FIG. 8.

Referring to FIGS. 7 through 9, as the substrate 500 moves along the first direction, a thin film may be formed on the substrate 500 sequentially from the first side of the substrate 500 to the second side thereof.

The first direction may be a negative direction of a y axis in FIG. 7. That is, in a state where the first side of the substrate 500 is placed parallel to the lengthwise direction of the thin film forming apparatus, the substrate 500 may move along the first direction, that is, in the direction perpendicular to the lengthwise direction of the thin film forming apparatus.

Referring to FIG. 8, when the first side of the substrate 500 is adjacent to the thin film forming apparatus, the first organic material may be sprayed from the first nozzle unit 101. That is, the first nozzle unit 101 may provide the first organic material toward the substrate 500. The first nozzle unit 101 may spray the first organic material continuously or discontinuously as the substrate 500 moves. At the same time as or after the first nozzle unit 101 sprays the first organic material, the first light-irradiating unit 111 may irradiate light toward the first organic material provided on the substrate 500. Accordingly, the first organic material provided on the substrate 500 may be cured. In an example, the first light-irradiating unit 111 may irradiate the first UV light that can cure the first organic material as described above.

The substrate 500 may continuously move through the above process. Then, when the second side of the substrate 500 finally passes the thin film forming apparatus, a first thin film 140 which is the cured first organic material may be formed on the substrate 500 (see FIG. 9).

For ease of description, a process of forming a thin film on the substrate 500 by moving the substrate 500 in the first direction will be defined as a first scan. The first scan may be a process of forming a thin film on the substrate 500 by moving the substrate 500, from the first side to the second side, over the thin film forming apparatus. That is, in the first scan, a thin film may be formed on an area of the substrate 500, which corresponds to the thin film forming apparatus, from the first side to the second side. In other words, the first scan may include a process of forming a thin film on the substrate 500 from the first side to the second side.

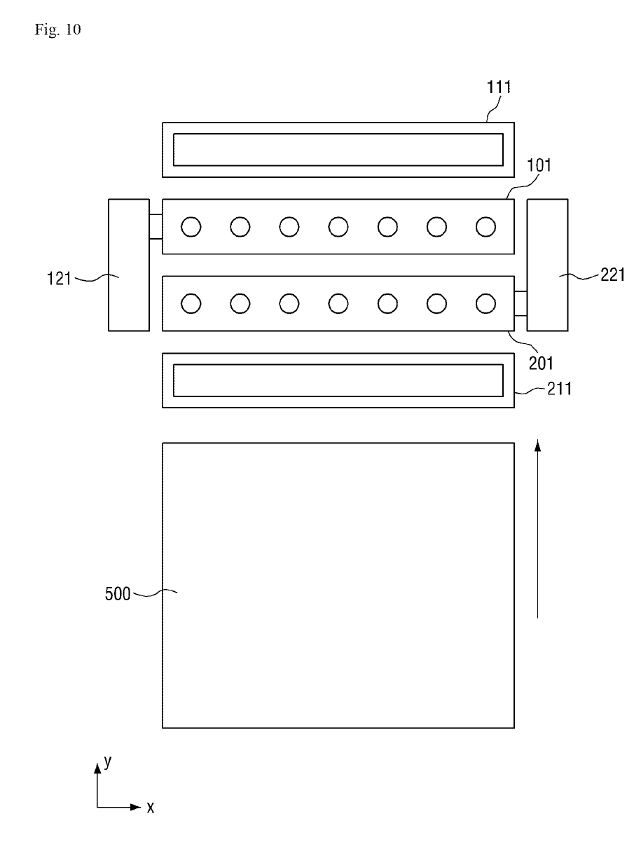

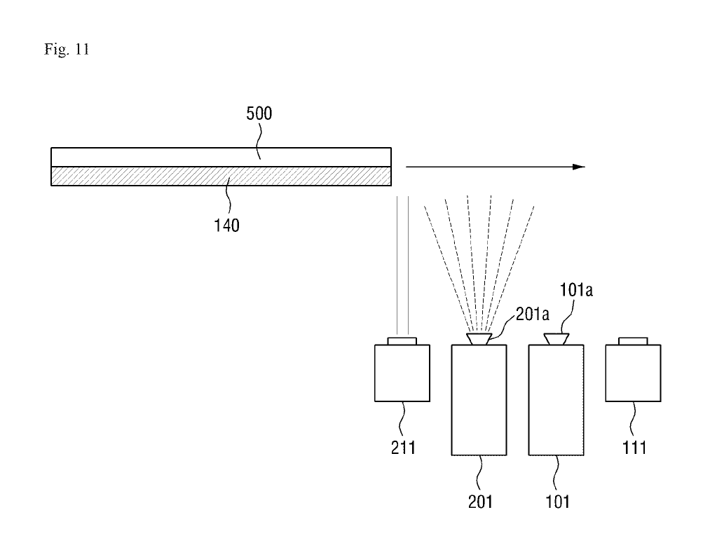

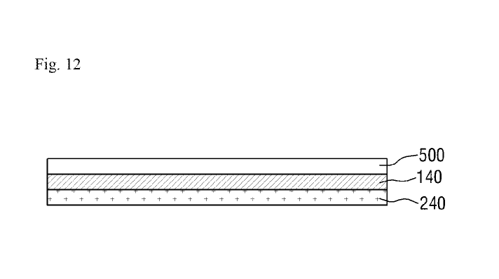

FIG. 10 is a plan view of the thin film forming apparatus of FIG. 3. FIG. 11 is a cross-sectional view of the thin film forming apparatus of FIG. 10. FIG. 12 is a cross-sectional view of the substrate 500 having a thin film formed by the thin film forming apparatus of FIG. 11.

Referring to FIG. 10, after the second side of the substrate 500 passes the thin film forming apparatus, that is, in a state where the second side of the substrate 500 is adjacent to the thin film forming apparatus, the substrate 500 may move in a second direction opposite to the first direction, that is, in a positive direction of the y axis in FIG. 10.

As the substrate 500 moves along the second direction, a thin film may be formed on the substrate 500 sequentially from the second side of the substrate 500 to the first side thereof.

In a state where the second side of the substrate 500 is parallel to the lengthwise direction of the thin film forming apparatus, the substrate 500 may move in the second direction, that is, in a direction perpendicular to the lengthwise direction of the thin film forming apparatus.

Referring to FIG. 11, when the second side of the substrate 500 is adjacent to the thin film forming apparatus, the second organic material may be sprayed from the second nozzle unit 201. That is, the second nozzle unit 201 may provide the second organic material toward the substrate 500. The second nozzle unit 201 may spray the second organic material continuously or discontinuously as the substrate 500 moves. At the same time as or after the second nozzle unit 201 sprays the second organic material, the second light-irradiating unit 211 may irradiate light toward the second organic material provided on the substrate 500. Accordingly, the second organic material provided on the substrate 500 may be cured.

The substrate 500 may continuously move through the above process. Then, when the first side of the substrate 500 finally passes the thin film forming apparatus, a second thin film 240 which is the cured second organic material may be formed on the substrate 500. The second thin film 240 may be formed to completely overlap or cover the first thin film 140, e.g., which is formed as discussed above, but the present embodiment is not limited thereto.

For ease of description, a process of forming a thin film on the substrate 500 by moving the substrate 500 in the second direction will be defined as a second scan. The second scan may be a process of forming a thin film on the substrate 500 by moving the substrate 500, from the second side to the first side, over the thin film forming apparatus. That is, in the second scan, a thin film may be formed on an area of the substrate 500, which corresponds to the thin film forming apparatus, from the second side to the first side. In other words, the second scan may include a process of forming a thin film on the substrate 500 from the second side to the first side.

The thin film forming apparatus according to the embodiments may perform the first scan and the second scan at least once. That is, after the first scan is performed, the second scan may be performed. Alternatively, after the first scan is performed, the thin film forming apparatus may be shifted in the lengthwise direction by a predetermined distance, and then the second scan may be performed. The first scan and the second scan may also be repeatedly performed in this order.

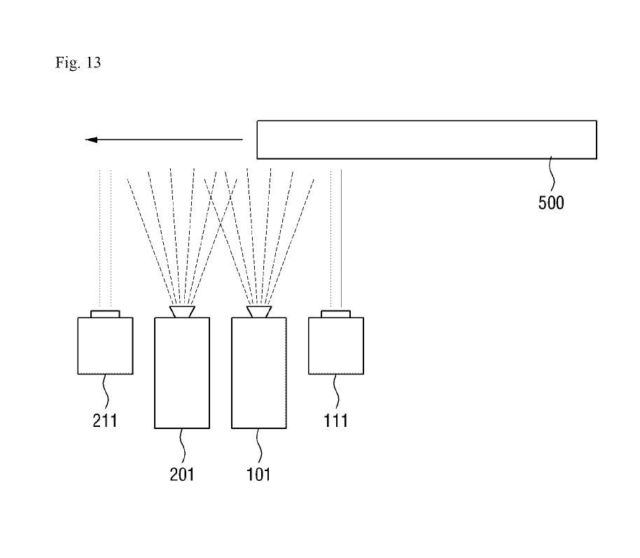

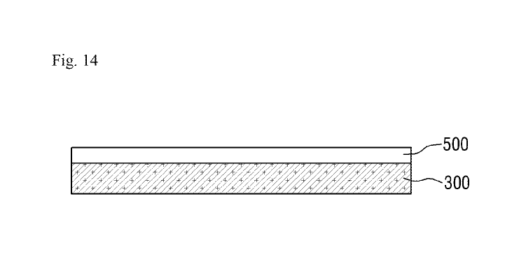

FIG. 13 is a cross-sectional view of the thin film forming apparatus of FIG. 7. FIG. 14 is a cross-sectional view of a substrate 500 having a thin film formed by the thin film forming apparatus of FIG. 13.

Referring to FIGS. 13 and 14, as the substrate 500 moves along the first direction, the first nozzle unit 101 and the second nozzle unit 201 may spray the first organic material and the second organic material simultaneously. That is, the current embodiment is different from the embodiment of FIG. 8 in that the first nozzle unit 101 and the second nozzle unit 201 operate simultaneously during the first scan.

Specifically, when a first side of the substrate 500 is adjacent to the thin film forming apparatus, the first nozzle unit 101 and the second nozzle unit 201 may spray the first organic material and the second organic material. That is, the first nozzle unit 101 may spray the first organic material onto the substrate 500, and the second nozzle unit 202 may spray the second organic material onto the substrate 500. As the substrate 500 moves, the first nozzle unit 101 and the second nozzle unit 201 may spray the first organic material and the second organic material continuously or discontinuously. At the same time as or after the first nozzle unit 101 and the second nozzle unit 201 spray the first organic material and the second organic material, the first light-irradiating unit 111 and the second light-irradiating unit 211 may irradiate light to the first organic material and the second organic material provided on the substrate 500. That is, the first light-irradiating unit 111 may irradiate the first UV light having a wavelength that cures the first organic material, and the second light-irradiating unit 211 may irradiate the second UV light having a wavelength that cures the second organic material.

The substrate 500 continuously moves through the above process. Then, when a second side of the substrate 500 finally passes the thin film forming apparatus, a third thin film 300, which is a cured mixture of the first organic material and the second organic material, may be formed on the substrate 500 (see FIG. 14).

A case where the first thin film 140 and the second thin film 240 are sequentially stacked on the substrate 500 and a case where the third thin film 300 is formed by curing a mixture of the first organic material and the second organic material have been described above as examples. However, thin films formed by the thin film forming apparatus according to the embodiments are not limited to these examples. That is, various thin films can be formed by controlling the first nozzle unit 101 and the second nozzle unit 201.

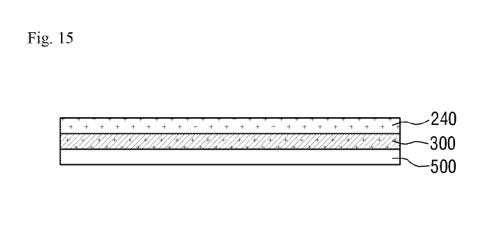

FIGS. 15 through 18 are cross-sectional views of thin films formed on a substrate 500 by the thin film forming apparatus of FIG. 3.

Referring to FIG. 15, a second thin film 240 may be disposed on a third film 300.

In a first scan, the first nozzle unit 101 and the second nozzle unit 201 may spray the first organic material and the second organic material simultaneously, and the first light-irradiating unit 111 and the second light-irradiating unit 211 may irradiate the first UV light and the second UV light. As a result, the third thin film 300 may be formed.

After the formation of the third film 300, a second scan may be performed. In the second scan, the second nozzle unit 201 may spray the second organic material, and the second light-irradiating unit 211 may irradiate the second UV light. As a result, the second thin film 240 may be formed.

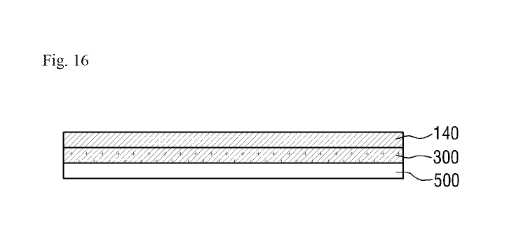

Referring to FIG. 16, a first thin film 140 may be disposed on a third thin film 300.

In a first scan, the first nozzle unit 101 and the second nozzle unit 201 may spray the first organic material and the second organic material simultaneously, and the first light-irradiating unit 111 and the second light-irradiating unit 211 may irradiate the first UV light and the second UV light. As a result, the third thin film 300 may be formed. After the formation of the third film 300, a second scan may be performed. In the second scan, the first nozzle unit 101 may spray the first organic material, and the first light-irradiating unit 111 may irradiate the first UV light. As a result, the first thin film 140 may be formed.

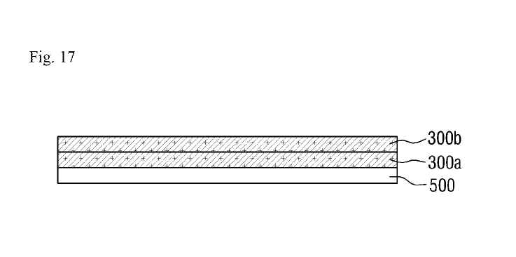

Referring to FIG. 17, a third thin film 300 may be stacked continuously.

In a first scan, the first nozzle unit 101 and the second nozzle unit 201 may spray the first organic material and the second organic material simultaneously, and the first light-irradiating unit 111 and the second light-irradiating unit 211 may irradiate the first UV light and the second UV light. As a result, a first third thin film 300a may be formed. Then, in a second scan, the first nozzle unit 101 and the second nozzle unit 201 may spray the first organic material and the second organic material simultaneously, and the first light-irradiating unit 111 and the second light-irradiating unit 211 may irradiate the first UV light and the second UV light. As a result, a second third thin film 300b may be formed. That is, the same types of thin films may be formed in the first scan and the second scan. Accordingly, a relatively thicker thin film than a thin film formed by one scan can be formed.

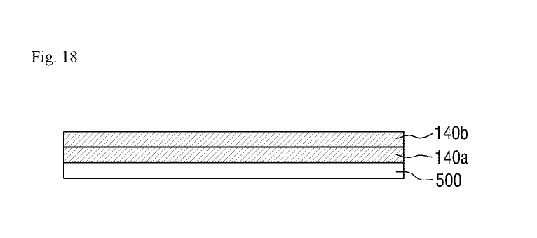

That is, the third thin films 300a and 300b may be formed by simultaneously operating the first nozzle unit 101 and the second nozzle unit 201 as illustrated in FIG. 17, or the same thin film may be stacked sequentially by operating any one of the first nozzle unit 101 and the second nozzle unit 201. In FIG. 18, a case where only the first nozzle unit 101 is operated during the first and second scans is illustrated to form first thin films 140a, 140b.

Hereinafter, other embodiments will be described. In the following embodiments, elements identical to those described above are indicated by like reference numerals, and a redundant description thereof will be omitted or given briefly.

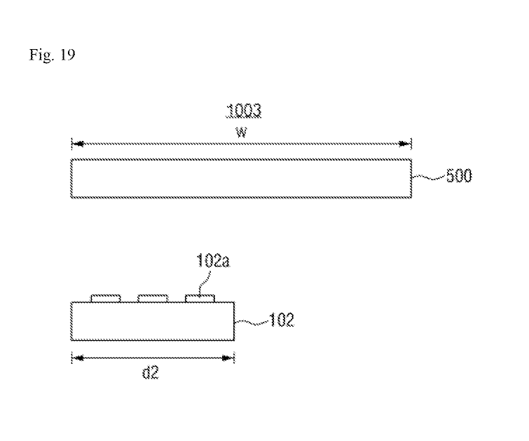

FIG. 19 is a cross-sectional view of a thin film forming apparatus 1003 according to another embodiment.

Referring to FIG. 19, the thin film forming apparatus 1003 according to the current embodiment is different from the thin film forming apparatus according to the embodiment of FIG. 5 in that its length is relatively smaller than a width of a substrate.

In an exemplary embodiment, a length d2 of the thin film forming apparatus 1003 may be relatively smaller than a width w of a substrate 500. When the length d2 of the thin film forming apparatus 1003 is smaller than the width w of the substrate 500, the thin film forming apparatus 1003 may perform a first scan and a second scan one or more times in order to form a thin film.

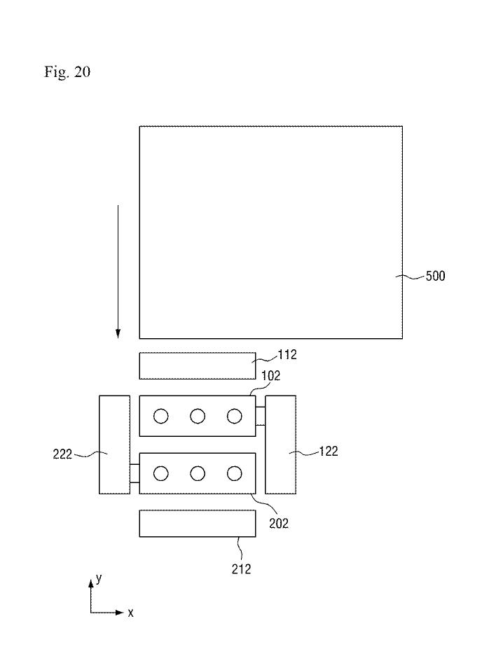

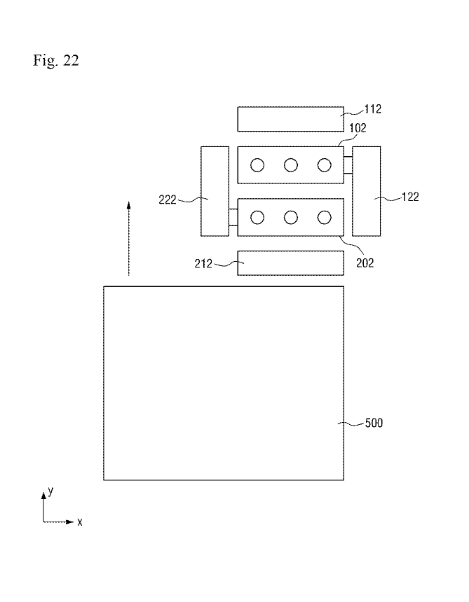

The current embodiment will now be described in detail with reference to FIGS. 20 through 22.

FIGS. 20 through 22 are plan views illustrating the operation of the thin film forming apparatus of FIG. 19.

Referring to FIGS. 20 through 22, the thin film forming apparatus according to the current embodiment may perform the first scan and the second scan one or more times.

In a state where a first side of the substrate 500 is placed parallel to a lengthwise direction of the thin film forming apparatus, the substrate 500 may move in a first direction, that is, a direction perpendicular to the lengthwise direction of the thin film forming apparatus. In this way, the first scan may be performed.

As the substrate 500 moves in the first direction, any one or more of a first nozzle unit 102 and a second nozzle unit 202 may operate to spray at least one or more of a first organic material and a second organic material onto the substrate 500. In addition, any one or more of a first light-irradiating unit 112 and a second light-irradiating unit 212 may irradiate any one or more of first UV light and second UV light onto the substrate 500.

The first nozzle unit 102, the second nozzle unit 202, the first light-irradiating unit 112 and the second light-irradiating unit 212 may operate in substantially the same way as those of the thin film forming apparatus according to the previous embodiment of FIG. 3, and thus a detailed description thereof will be omitted.

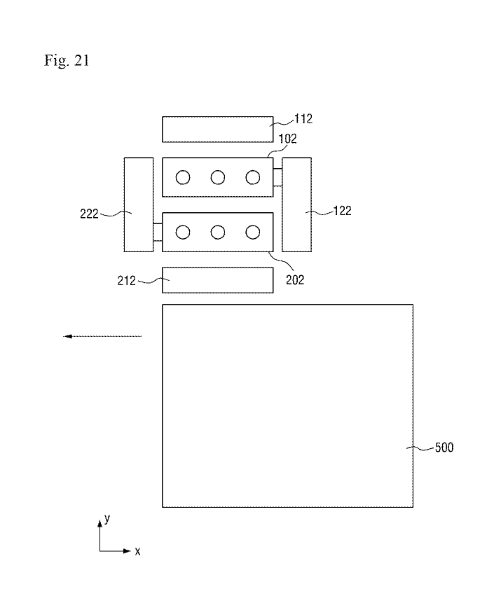

After the first scan, the thin film forming apparatus may be placed adjacent to a second side of the substrate 500. In this state, the substrate 500 may be shifted by a predetermined distance in the lengthwise direction of the thin film forming apparatus, that is, in a third direction perpendicular to the first direction or a second direction. In an exemplary embodiment, the substrate 500 may be shifted by, but not limited to, the length d2 of the thin film forming apparatus (see FIG. 21).

After the substrate 500 is shifted in the lengthwise direction, the second scan may be performed. That is, the substrate 500 may pass over the thin film forming apparatus sequentially from the second side of the substrate 500 to the first side thereof. Accordingly, a thin film may be formed on the substrate 500 sequentially from the second side to the first side.

In FIGS. 20 through 22, the first scan and the second scan each are performed once, but the number of scans is not limited thereto. That is, the thin film forming apparatus according to the embodiments may perform the first scan, a shift in the lengthwise direction, and the second scan one or more times. In other words, the first scan, a shift in the lengthwise direction, and the second scan may be repeatedly performed one or more times in this order.

Accordingly, one or more organic thin films may be formed on the whole area of the substrate 500.

Hereinafter, a thin film forming method according to an embodiment will be described.

The thin film forming method according to the current embodiment includes a first scan operation of forming a first thin film on a substrate by moving the substrate in a first direction, a second scan operation of forming a second thin film by moving the substrate in a second direction opposite to the first direction. Each of the first scan operation and the second scan operation includes providing any one or more of a first organic material and a second organic material onto the substrate and irradiating any one or more of first UV light and second UV light onto the substrate.

The thin film forming method according to the current embodiment may be performed by a thin film forming apparatus according to embodiments. However, the thin film forming method according to the current embodiment is not limited thereto.

First, the first scan operation of forming a first thin film on a substrate by moving the substrate in the first direction is performed.

The first scan operation will now be described by referring to FIGS. 7 through 9 again. For ease of description, a method of forming a thin film using a thin film forming apparatus according to embodiments will be described as an example. However, the scope of the present embodiment is not limited by this example as described above.

The first scan operation may include providing any one or more of the first organic material and the second organic material onto the substrate and irradiating any one or more of the first UV light and the second UV light onto the substrate. The providing of any one or more of the first organic material and the second organic material onto the substrate may be performed by any one or more of a first nozzle unit 101 and a second nozzle unit 201. In addition, the irradiating of any one or more of the first UV light and the second UV light onto the substrate may be performed by any one or more of a first light-irradiating unit 111 and a second light-irradiating unit 211. However, this is merely an example, and the present embodiment is not limited to this example. A more detailed description is as follows.

A case where the first thin film is formed by the first organic material sprayed from the first nozzle unit 101 will be described below as an example, but the present embodiment is not limited to this case. That is, in the first scan operation, any one of the first organic material, the second organic material, and a mixture of the first organic material and the second organic material may be formed as described above.

The first direction may be the negative direction of the y axis in FIG. 7. That is, in a state where a first side of a substrate 500 is placed parallel to a lengthwise direction of the thin film forming apparatus, the substrate 500 may move along the first direction, that is, in a direction perpendicular to the lengthwise direction of the thin film forming apparatus.

Referring to FIG. 8, when the first side of the substrate 500 is adjacent to the thin film forming apparatus, the first nozzle unit 101 may spray the first organic material. That is, the first nozzle unit 101 may provide the first organic material toward the substrate 500. The first nozzle unit 101 may spray the first organic material continuously or discontinuously as the substrate 500 moves. At the same time as or after the first nozzle unit 101 sprays the first organic material, the first light-irradiating unit 111 may irradiate light toward the first organic material provided on the substrate 500. Accordingly, the first organic material provided on the substrate 500 may be cured. In an example, the first light-irradiating unit 111 may irradiate the first UV light that can cure the first organic material as described above.

The substrate 500 may continuously move through the above process. Then, when a second side of the substrate 500 finally passes the thin film forming apparatus, a first thin film 140 which is the cured first organic material may be formed on the substrate 500 (see FIG. 9).

After the first scan operation, the second scan operation may be performed. The second scan operation may be an operation of forming the second thin film by moving the substrate in the second direction opposite to the first direction.

The second scan operation will now be described by referring to FIGS. 10 through 12 again. For ease of description, a method of forming a thin film using a thin film forming apparatus according to embodiments will be described as an example. However, the scope of the present embodiment is not limited by this example as described above.

The second scan operation may include providing any one or more of the first organic material and the second organic material onto the substrate and irradiating any one or more of the first UV light and the second UV light onto the substrate. The providing of any one or more of the first organic material and the second organic material onto the substrate may be performed by any one or more of the first nozzle unit 101 and the second nozzle unit 201. In addition, the irradiating of any one or more of the first UV light and the second UV light onto the substrate may be performed by any one or more of the first light-irradiating unit 111 and the second light-irradiating unit 211. However, this is merely an example, and the present embodiment is not limited to this example. A more detailed description is as follows.

A case where the second thin film is formed by the second organic material sprayed from the second nozzle unit 201 will be described below as an example, but the present embodiment is not limited to this case. That is, in the second scan operation, any one of the first organic material, the second organic material, and a mixture of the first organic material and the second organic material may be formed as described above.

Referring to FIG. 10, after the second side of the substrate 500 passes the thin film forming apparatus, that is, in a state where the second side of the substrate 500 is adjacent to the thin film forming apparatus, the substrate 500 may move in the second direction opposite to the first direction, that is, in the positive direction of the y axis in FIG. 10.

As the substrate 500 moves along the second direction, a thin film may be formed on the substrate 500 sequentially from the second side of the substrate 500 to the first side thereof.

In a state where the second side of the substrate 500 is parallel to the lengthwise direction of the thin film forming apparatus, the substrate 500 may move in the second direction, that is, a direction perpendicular to the lengthwise direction of the thin film forming apparatus.

Referring to FIG. 11, when the second side of the substrate 500 is adjacent to the thin film forming apparatus, the second organic material may be sprayed from the second nozzle unit 201. That is, the second nozzle unit 201 may provide the second organic material toward the substrate 500. The second nozzle unit 201 may spray the second organic material continuously or discontinuously as the substrate 500 moves. At the same time as or after the second nozzle unit 201 sprays the second organic material, the second light-irradiating unit 211 may irradiate light toward the second organic material provided on the substrate 500. Accordingly, the second organic material provided on the substrate 500 may be cured.

The substrate 500 may continuously move through the above process. Then, when the first side of the substrate 500 finally passes the thin film forming apparatus, a second thin film 240 which is the cured second organic material may be formed on the substrate 500. The second thin film 240 may be formed to completely overlap or cover the first thin film 140, but the present embodiment is not limited thereto.

The thin film forming method according to the current embodiment may further include shifting the substrate in a third direction perpendicular to the first direction or the second direction between the first scan operation and the second scan operation. The shifting of the substrate in the third direction will now be described by referring to FIGS. 20 through 22 again.

In a state where the first side of the substrate 500 is placed parallel to the lengthwise direction of the thin film forming apparatus, the substrate 500 may move in the first direction, that is, the direction perpendicular to the lengthwise direction of the thin film forming apparatus. In this way, a first scan operation may be performed.

As the substrate 500 moves in the first direction, any one or more of the first nozzle unit 102 and the second nozzle unit 202 may operate to spray at least one or more of the first organic material and the second organic material onto the substrate 500. In addition, any one or more of the first light-irradiating unit 112 and the second light-irradiating unit 212 may irradiate any one or more of first UV light and second UV light onto the substrate 500.

The first nozzle unit 102, the second nozzle unit 202, the first light-irradiating unit 112 and the second light-irradiating unit 212 may operate in substantially the same way as those of the thin film forming apparatus according to the previous embodiment of FIG. 3, and thus a detailed description thereof will be omitted.

After the first scan operation, the thin film forming apparatus may be placed adjacent to the second side of the substrate 500. In this state, the substrate 500 may be shifted by a predetermined distance in the lengthwise direction of the thin film forming apparatus, that is, in the third direction perpendicular to the first direction or the second direction. In an exemplary embodiment, the substrate 500 may be shifted by, but not limited to, the length d2 of the thin film forming apparatus (see FIG. 21).

After the substrate 500 is shifted in the lengthwise direction, a second scan operation may be performed. That is, the substrate 500 may pass over the thin film forming apparatus sequentially from the second side of the substrate 500 to the first side thereof. Accordingly, a thin film may be formed on the substrate 500 sequentially from the second side to the first side.

Embodiments provide at least one of the following advantages.

That is, it is possible to reduce process time by simultaneously or sequentially forming a plurality of organic thin films on a substrate.

However, the effects of the inventive concept are not restricted to the one set forth herein. The above and other effects of the inventive concept will become more apparent to one of daily skill in the art to which the present application pertains by referencing the claims.

What is claimed is:

1. A thin film forming apparatus comprising:
a first storage unit configured to store a first organic material;
a first nozzle unit which is connected to the first storage unit and is configured to spray the first organic material stored in the first storage unit;
a first light-irradiating unit which is disposed adjacent to the first nozzle unit;
a second storage unit configured to store a second organic material;
a second nozzle unit which is disposed adjacent to the first nozzle unit, is connected to the second storage unit, and is configured to spray the second organic material stored in the second storage unit; and
a second light-irradiating unit which is disposed adjacent to the second nozzle unit.

2. The apparatus of claim 1, wherein the first storage unit and the second storage unit are configured to store the first organic material and the second organic material in a liquid form and further comprising a first vaporization unit and a second vaporization unit configured to vaporize the first organic material and the second organic material.

3. The apparatus of claim 1, wherein the first light-irradiating unit is configured to irradiate light having a wavelength that cures the first organic material, and the second light-irradiating unit is configured to irradiate light having a wavelength that cures the second organic material.

4. A thin film forming apparatus comprising:
a first nozzle unit and a second nozzle unit which extend along a lengthwise direction and are disposed side by side with each other;
a first storage unit which is connected to the first nozzle unit and is configured to store a first organic material;
a second storage unit which is connected to the second nozzle unit and is configured to store a second organic material;
a first light-irradiating unit which is disposed adjacent to a first side of the first nozzle unit and extends side by side with the first nozzle unit; and
a second light-irradiating unit which is disposed adjacent to a second side of the second nozzle unit and extends side by side with the second nozzle unit.

5. The apparatus of claim 4, wherein each of the first nozzle unit and the second nozzle unit comprises a body extending along the lengthwise direction and one or more spray holes formed on the body.

6. The apparatus of claim 4, wherein a substrate is placed above the first nozzle unit and the second nozzle unit to face the first nozzle unit and the second nozzle unit.

7. The apparatus of claim 6, wherein a width of the substrate corresponds to a length of the thin film forming apparatus.

8. The apparatus of claim 6, wherein the substrate moves horizontally along a first direction perpendicular to the lengthwise direction or along a second direction different from the first direction.

9. The apparatus of claim 8, wherein a first scan is defined as a process of forming a thin film on the substrate by moving the substrate along the first direction, and a second scan is defined as a process of forming a thin film on the substrate by moving the substrate along the second direction.

10. The apparatus of claim 9, wherein during the first scan, the first nozzle unit provides the first organic material to the substrate, and the first light-irradiating unit irradiate first ultraviolet light (UV) having a wavelength that cures the first organic material toward the substrate, and during the second scan, the second nozzle unit provides the second organic material to the substrate, and the second light-irradiating unit irradiates second UV light having a wavelength that cures the second organic material toward the substrate.

11. The apparatus of claim 10, wherein a first thin film is formed on the substrate during the first scan, and a second thin film is formed on the first thin film during the second scan.

12. The apparatus of claim 9, wherein during the first scan, the first nozzle unit and the second nozzle unit provide the first organic material and the second organic material to the substrate, and the first light-irradiating unit and the second light-irradiating unit irradiate the first UV light that cures the first organic material and the second UV light that cures the second organic material to the substrate.

13. The apparatus of claim 12, wherein during the first scan, a third thin film is formed on the substrate by curing a mixture of the first organic material and the second organic material.

14. The apparatus of claim 9, wherein after the first scan, the substrate is shifted along the lengthwise direction by a predetermined distance.

15. The apparatus of claim 9, wherein the substrate moves along any one of the first direction, the second direction, and the third direction perpendicular to the first direction and the second direction.

16. A thin film forming method comprising:
a first scan operation of forming a first thin film on a substrate by moving the substrate along a first direction; and
a second scan operation of forming a second thin film by moving the substrate along a second direction opposite to the first direction,
wherein each of the first scan operation and the second scan operation comprises:
providing any one or more of a first organic material and a second organic material onto the substrate; and
irradiating any one or more of first UV light and second UV light onto the substrate.

17. The method of claim 16, wherein during the first scan operation, the first organic material is provided to the substrate, and the first UV light having a wavelength that cures the first organic material is irradiated toward the substrate, and during the second scan operation, the second organic material is provided to the substrate, and the second UV light having a wavelength that cures the second organic material is irradiated toward the substrate.

18. The method of claim 16, wherein during the first scan operation, the first organic material and the second organic material are provided to the substrate, and the first UV light having a wavelength that cures the first organic material and the second UV light having a wavelength that cures the second organic material are irradiated toward the substrate.

19. The method of claim 16, further comprising shifting the substrate along a third direction perpendicular to the first direction or the second direction between the first scan operation and the second scan operation.
